(19) United States
(12) Patent Application Publication
(10) Pub. No.: US 2018/0157408 A1
(43) Pub. Date: Jun. 7, 2018

(54) MOBILE TERMINAL AND CONTROL METHOD THEREFOR

(71) Applicant: LG ELECTRONICS INC., Seoul (KR)

(72) Inventors: Joohyun YU, Seoul (KR); Jinwook CHOI, Seoul (KR); Wonseok YOU, Seoul (KR); Hangbeum CHO, Seoul (KR)

(73) Assignee: LG ELECTRONICS INC., Seoul (KR)

(21) Appl. No.: 15/580,030

(22) PCT Filed: Aug. 12, 2015
(86) PCT No.: PCT/KR2015/008447

§ 371 Date: Dec. 6, 2017

(30) Foreign Application Priority Data
Jul. 9, 2015 (KR) 10-2015-0097918

(51) Int. Cl. G06F 3/0488; H04M 1/725; G06F 3/0484; G06F 3/0486; G06F 3/0483; G06F 3/0482

(52) U.S. Cl. CPC G06F 3/04883; H04M 1/72547; G06F 3/04842; G06F 3/0482; G06F 3/0483; G06F 3/04845; G06F 3/0486

(57) ABSTRACT

In a mobile terminal, according to one embodiment of the present invention, for achieving the object as above, a wireless communication unit, a touch screen and a control unit cooperate with each other to perform a message transmission function. The control unit performs the message transmission function through a step of controlling the touch screen to output a message written by a user input; a step of outputting, in the case where the message includes content related to a file attachment, one or more files that can be attached to the message in a selectable link form using the content related to the file attachment; and a step of attaching, if at least one is selected from among the one or more files outputted in a link form, the at least one selected file to the message.

### TECHNICAL FIELD

The present invention relates to a mobile terminal providing a message transmission function and a method for controlling the same.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As the mobile terminal becomes multifunctional, it is implemented as a multimedia player having complicated functions such as capturing images or videos, playing music or videos, playing games, and receiving broadcastings.

Various attempts have been made to implement complicated functions in such a multimedia device by means of hardware or software.

As the communication technology is developed, various types of messages can be prepared and transmitted from one terminal to other terminals. The message includes a short message service, a long message service, a multimedia message service, an email, a messenger service, and the like.

Meanwhile, for the sake of the characteristics of the mobile terminal, since the size of the display is limited, necessity for a new type of UI (User Interface), which is different from the existing UI (User Interface) provided by a conventional computer monitor, is on the rise.

### DISCLOSURE OF THE INVENTION

Therefore, an object of the present invention is to solve the problems as above.

Another object of the present invention is to provide a message transmission function, considering user's convenience.

Still another object of the present invention is to provide a mobile terminal and a method for controlling the same, capable of comprehending content of a message and providing a function related to the content of the message so that an error such as a missing of an attachment file is prevented in advance.

Still another object of the present invention is to provide a mobile terminal and a method for controlling the same, having an artificial intelligence that can take care of user's errors as if it is a user's secretary in preparing a message.

Still another object of the present invention is to provide a mobile terminal providing an interface that can simply add content contained in an attachment file to a message.

### Technical Solution

To achieve these and other advantages and in accordance with the purpose of the present disclosure, as embodied and broadly described herein, there is provided a mobile terminal in which a wireless communication unit, a touch screen and a controller perform a message transmission function in cooperation with each other. The controller may execute the steps of: controlling the touch screen to output a message prepared by a user input; outputting one or more files that can be attached to the message in a selectable link form, when the message includes content related to a file attachment, using the content related to the file attachment; and attaching the selected at least one to the message when at least one is selected from the one or more files outputted in a link form.

In one embodiment, outputting one or more selectable files in a link form may include: selecting, when the message includes content related to the file attachment, one or more files corresponding to the content related to the file attachment among plural files stored in a memory; and controlling the touch screen to output the selected one or more files to one region of the touch screen in a selectable link form.

In one embodiment, the controller may further perform the step of, when a touch input is applied to any one file among the one or more files outputted in a link form, controlling the touch screen to output content included in the any one file to one region of the touch screen.

In one embodiment, the controller may further perform the step of, when a drag input to a region where the message is outputted from the one region of the touch screen is received while the contents is outputted to one region of the touch screen, inserting the contents into content of the message.

In one embodiment, the contents may be any one page among plural pages constituting the any one file.

In one embodiment, inserting the contents into content of the message may include the steps of: capturing the any one page as an image in response to the drag input; and inserting the captured image into the content of message.

In one embodiment, the controller may further perform the step of, when a touch input is applied to one region of the touch screen while the any one page is outputted from the one region of the touch screen, converting the any one page into another page based on the applied touch input.

In one embodiment, when the any one page is outputted to one region of the touch screen, a page number corresponding to the any one page may be outputted to the any one page.

In one embodiment, when the selected one or more files are plural, the plural files may be stored in different directories, and the plural files stored in different directories may be outputted together to one region of the touch screen in a selectable link form.

In one embodiment, a graphic object associated with the message transmission function may be outputted together with the message, and the controller may further perform the step of outputting the graphic object in an active state that the graphic object is touchable, or in an inactive state that the graphic object is untouchable according to whether the message satisfies a preset condition.

In one embodiment, the one or more files may be varied according to content related to the file attachment.

In one embodiment, an execution screen of an application corresponding to the message preparation function may be outputted to an entire region of the touch screen, and a popup window that outputs the one or more files in a selectable link form may be outputted to one region of the touch screen.

In one embodiment, the controller may further perform the steps of: controlling the touch screen to modify at least one of a size and position of the popup window based on a touch applied to an edge of the popup window; and outputting, when the size of the popup window is modified, the one or more files in different manners according to the modified size of the popup window.

In one embodiment, the size of the popup window may be varied according to the number of the one or more files.

In one embodiment, the controller may further perform the step of, when at least one is selected among the one or more files outputted in a link form, generating a title of the message using a file name of the selected at least one.

In one embodiment, the controller may further perform the step of, when a transmission command to the message is received in a state that an attached file is missed, but the message includes content related to the file attachment, outputting a notification information in at least one of visual, aural and tactile methods to notify missing of the attached file; and restricting the transmission of message.

In one embodiment, when at least one is selected from the one or more files outputted in a link form, the one or more files outputted in a link form may disappear from the touch screen.

Further, to achieve these and other advantages and in accordance with the purpose of the present invention, as embodied and broadly described herein, there is also provided a method for controlling the mobile terminal, in which a wireless communication unit, a touch screen and a controller perform a message transmission function in cooperation with each other. The controller may perform the steps of: controlling the touch screen to output a message received through the wireless communication unit; outputting a message preparation window including content of the message, based on a user request; outputting, when the message includes a file attached by a sender terminal that transmits the message, the attached file to one region of the touch screen in a selectable link form; and controlling, when the attached file outputted in a link form is selected, the touch screen to output contents included in the attached file to one region of the touch screen.

In one embodiment, when the attached file is modified by a user input and stored in a memory, a graphic object corresponding to the file stored in the memory may be further outputted to one region of the touch screen.

In one embodiment, when a touch input is applied to the graphic object, the controller may control the touch screen to output contents included in the file stored in the memory to one region of the touch screen.

### Advantageous Effect

The mobile terminal and method for controlling the same according to the present invention provide the following effects.

According to at least one of the embodiments of the present invention, since one or more files that can be automatically attached to a message by information included in the message may be recommended, a user does not need to search files to be attached one by one, and can visually recognize without forgetting to attach a file.

Further, according to at least one of the embodiments of the present invention, since the files to be attached are automatically recommended according to content of the message and the files to be attached are displayed on a popup window, a user can select the files to be attached while checking the content of the message. As a file attachment can be made without converting a screen, user convenience may be increased.

In general, since files stored in different directories are not displayed together, a user has to check a large number of directories to search a file to be attached. However, according to the present invention, it is possible to recommend related files to a user by simultaneously displaying the files stored in different directories based on information included in a message.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

FIG. 1A is a block diagram illustrating a mobile terminal related to the present invention;

FIGS. 1B and 1C are conceptual views illustrating an example of the mobile terminal according to the present invention, viewed from different directions;

FIG. 2 is a conceptual view illustrating a modified example of the mobile terminal according to the present invention;

FIG. 3 is a perspective view illustrating an example of a watch type mobile terminal according to one embodiment according to the present invention;

FIG. 4 is a flowchart representatively illustrating a control method of the present invention;

FIG. 5 is a conceptual view for explaining the control method of FIG. 4;

FIGS. 6A through 6G are exemplary views for explaining operations of the mobile terminal according to the present invention;

FIGS. 7A through 7C are conceptual views for explaining a method to recommend a related file based on content related to a file attachment;

FIGS. 8A and 8B are conceptual views for explaining an operation of a mobile terminal in a case where an attachment file is missed;

FIG. 9 is a flowchart illustrating a control method of the mobile terminal according to the present invention;

FIGS. 10A and 10B and 11 are conceptual views illustrating the control method of FIG. 9;

FIGS. 12A through 12C are conceptual views illustrating various embodiments related to a message transmission function; and

FIGS. 13A and 13B are conceptual views for explaining an artificial intelligence operation of the mobile terminal that operates as if it is a secretary of a user, according to the present invention.

### MODES FOR CARRYING OUT THE PREFERRED EMBODIMENTS

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

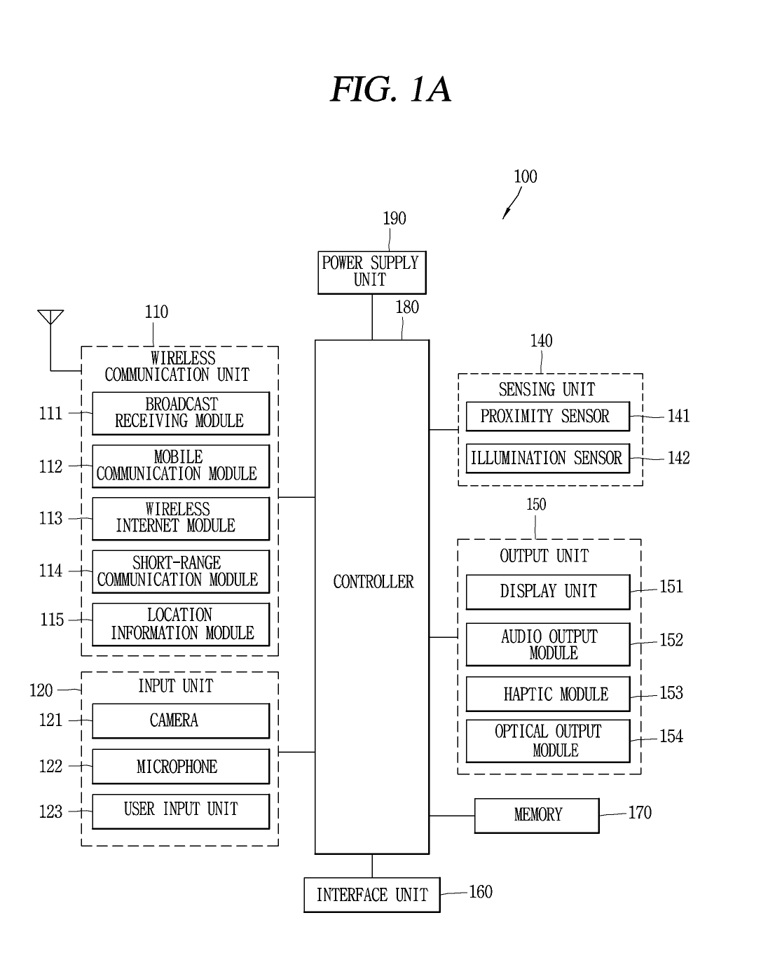

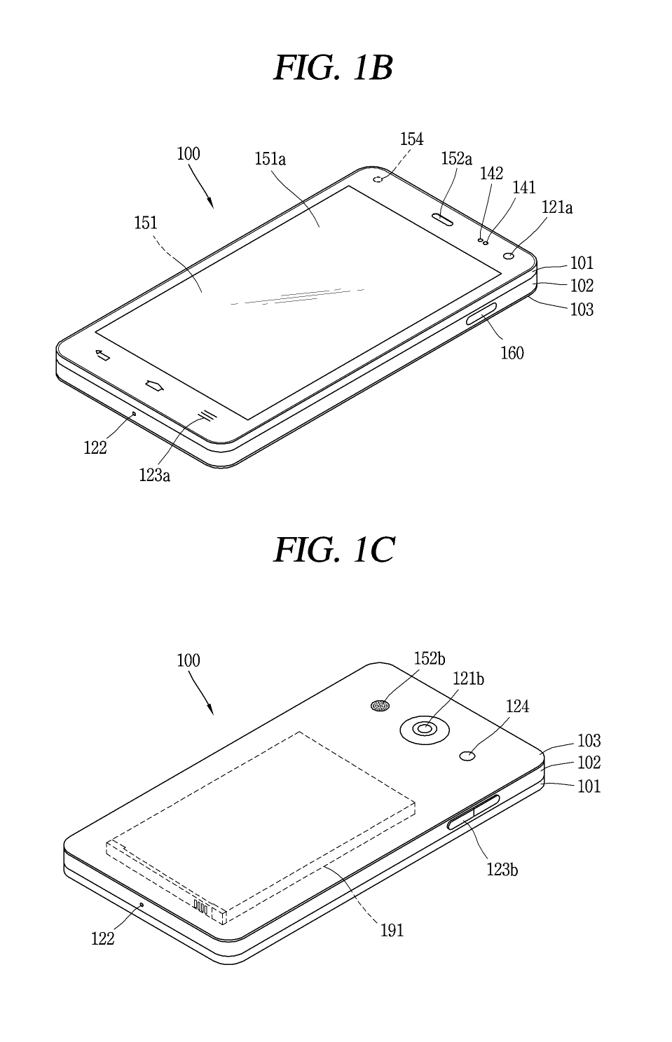

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components, or activating application programs stored in the memory 170.

The controller 180 controls some or all of the components illustrated in FIG. 1A in order to drive an application program stored in the memory 170. Further, the controller 180 may operate at least two of the components of the mobile terminal 100 in order to drive the application program. The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the above components may operate in a cooperating manner, so as to implement an operation or a control method for a mobile terminal according to various embodiments to be explained later. The operation or the control method for the mobile terminal may be implemented on the mobile terminal by driving at least one application program stored in the memory 170.

Before explaining various embodiments of the mobile terminal 100, the aforementioned components will be explained in more detail with reference to FIG. 1A.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network-storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The terminal body may be understood as at least one assembly of the mobile terminal 100.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal may be provided with a display unit 151, first and second audio output modules 152a, 152b, a proximity sensor 141, an illumination sensor 142, an optical output module 154, first and second cameras 121a, 121b, first and second manipulation units 123a, 123b, a microphone 122, an interface 160, etc.

Hereinafter, as shown in FIGS. 1B and 1C, will be explained the mobile terminal 100 having the display unit 151, the first audio output module 152a, the proximity sensor 141, the illumination sensor 142, the optical output module 154, the first camera 121a and the first manipulation unit 123a on the front surface of the terminal body, having the second manipulation unit 123b, the microphone 122 and the interface unit 160 on the side surfaces of the terminal body, and having the second audio output module 152b and the second camera 121b on the rear surface of the terminal body.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. For example, the display unit 151 may display execution screen information of an application program executing at the mobile terminal 100 or user interface (UI) and graphic user interface (GUI) information in response to the execution screen information.

The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

In the present invention, information processed in the mobile terminal may be displayed on a flexible display. This will be explained in more detail with reference to the attached drawings.

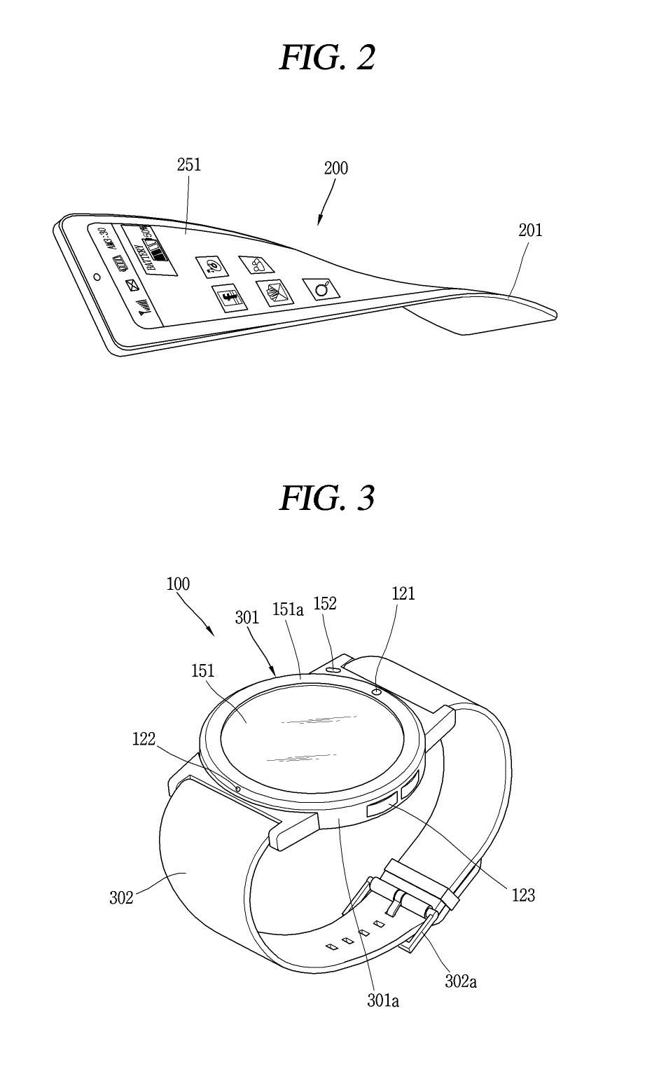

FIG. 2 is a conceptual view illustrating a modified example of a mobile terminal 200 according to the present invention.

As shown, a flexible display unit 251 is configured to be deformable by an external force. This deformation of the flexible display unit 251 may include any of curving, bending, folding, twisting, rolling, and combinations thereof. The deformable display unit 251 may also be referred to as a ‘flexible display unit’. Here, the flexible display unit 251 may include a general flexible display, and electronic paper.

The flexible display is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When the flexible display unit 251 is not deformed (for example, in a state with an infinite radius of curvature and referred to as a first state), a display region of the flexible display unit 251 includes a generally flat surface. When the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized so a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state (or a less curved state) or into a more curved state.

The flexible display unit 251 may form a flexible touch screen together with a touch sensor. When a touch input is applied to the flexible touch screen, the controller 180 (refer to FIG. 1A) may perform a control corresponding to the touch input. The flexible touch screen may sense a touch input not only in the first state, but also in the second state.

One option is to configure the mobile terminal 200 according to a modification embodiment of the present invention to include a deformation sensor which senses the deforming of the flexible display unit 251. The deformation sensor may be included in the sensing unit 140 (refer to FIG. 1A).

The deformation sensor may be located in the flexible display unit 251 or a case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Alternatively, such information may include various information sensible by bending of the flexible display unit 251.

In some embodiments, the controller 180 can change information displayed on the flexible display unit 251, or generate a control signal for controlling a function of the mobile terminal 200, based on the information related to the deforming of the flexible display unit 251.

The mobile terminal 200 according to the modification embodiment may further include a case 201 for accommodating the flexible display unit 251 therein. The case 201 may be configured to be transformable together with the flexible display unit 251 by an external force, taking into account characteristics of the flexible display unit 251.

A battery (not shown) located in the mobile terminal 200 may also be deformable in cooperation with the flexible display unit 251, taking into account the characteristic of the flexible display unit 251. One technique to implement such a battery is to use a stack and folding method of stacking battery cells.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 may transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

FIG. 3 is a perspective view illustrating one example of a watch-type mobile terminal 300 in accordance with another exemplary embodiment.

As illustrated in FIG. 3, the watch-type mobile terminal 300 includes a main body 301 with a display unit 351 and a band 302 connected to the main body 301 to be wearable on a wrist.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion (not shown) electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

Hereinafter, a communication system which is operable with the mobile terminal 100 according to the present disclosure will be described.

First, such communication systems utilize different air interfaces and/or physical layers. Examples of such air interfaces utilized by the communication systems include Frequency Division Multiple Access (FDMA), Time Division Multiple Access (TDMA), Code Division Multiple Access (CDMA), and Universal Mobile Telecommunications System (UMTS), the Long Term Evolution (LTE) of the UMTS, the Global System for Mobile Communications (GSM), and the like.

By way of non-limiting example only, further description will relate to a CDMA communication system, but such teachings apply equally to other system types including the CDMA wireless communication system.

A CDMA wireless communication system is shown having a plurality of display devices 100, a plurality of base stations (BSs), base station controllers (BSCs), and a mobile switching center (MSC). The MSC is configured to interface with a conventional Public Switch Telephone Network (PSTN). The MSC is also configured to interface with the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the display devices 100 operating within the system. The broadcast receiving module 111 (FIG. 1A) is typically configured inside the mobile terminal 100 to receive broadcast signals transmitted by the BT.

Global Positioning System (GPS) satellites 300 for checking a position of the mobile terminal 100 may be provided in a CDMA wireless communication system. Such satellites 300 facilitate locating the position of the mobile terminal 100. Two satellites are depicted, but it is understood that useful position information may be obtained with greater or fewer satellites than two satellites. The GPS module is typically configured to cooperate with the satellites 300 to obtain desired position information. It is to be appreciated that other types of position detection technology, (i.e., location technology that may be used in addition to or instead of GPS location technology) may alternatively be implemented. If desired, at least one of the GPS satellites 300 may alternatively or additionally be configured to provide satellite DMB transmissions.

Reference will now be made in detail to the preferred embodiments of a control method of the mobile terminal according to the present invention, examples of which are illustrated in the accompanying drawings. It will also be apparent to those skilled in the art that various modifications and variations can be made in the present invention without departing from the spirit or scope of the invention. In the following descriptions, the drawings will be sequentially explained in a clockwise direction on the basis of the left upper drawing.

The mobile terminal 100 may transmit/receive a message to/from an external terminal and/or a server. In this instance, the transmitted/received message may be named in various titles. For instance, the transmitted/received message may be named as a text message, an instant message (IM), an email, an electronic document, and the like.

In the following drawings, explanation is given of a case that the message is an email, but not limited thereto and the present invention may be applicable to all types of information that can be transmitted/received through the communication.

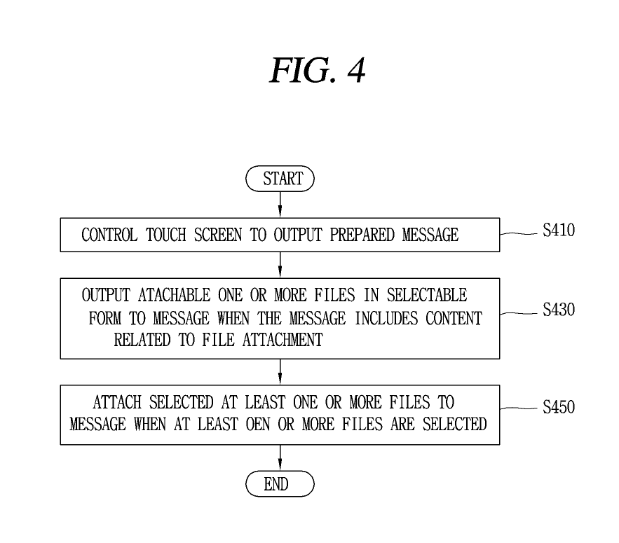

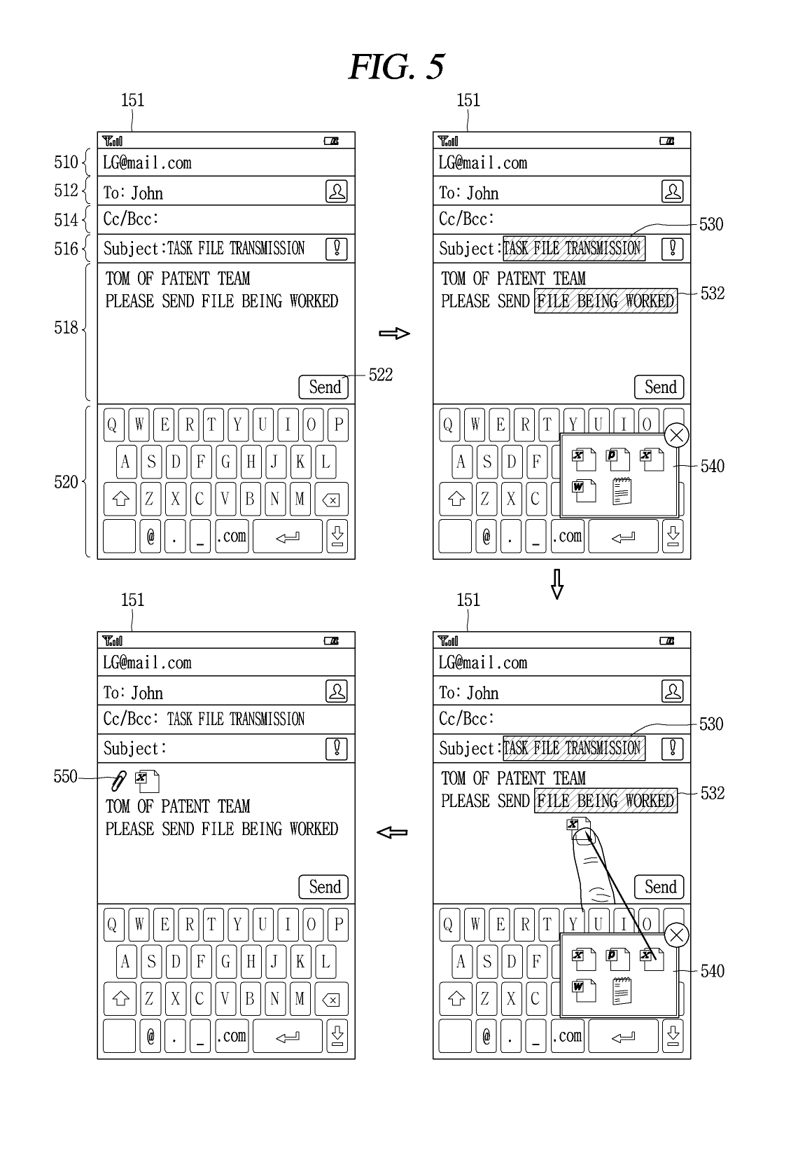

FIG. 4 is a representative flowchart illustrating a control method according to the present invention, and FIG. 5 is a conceptual view for explaining the control method of FIG. 4.

The mobile terminal 100 according to the present invention includes a wireless communication unit 110, a touch screen 151 and a controller 180, and the above components perform a message transmission function in cooperation with each other.

The message transmission function may mean a function that receives an input of a message from a user by executing an application related to a message transmission, and transmits the inputted message to a server so as to be transmitted to another party's terminal.

The application has the concept to include a widget or a home launcher, and may mean all types of programs that may be operable in a mobile terminal. Thus, the application related to the operation of the message transmission may be a program that executes a function of message transmission/reception.

The controller 180 may control the touch screen 151 to output a message prepared by a user input (S410). To this end, the controller 180 may output a message input window (or, a message generation window), formed to receive an input of a message, to the touch screen 151.

For instance, as shown in FIG. 5, an email application is executed and an execution screen of the email application may be outputted to the touch screen 151. The execution screen may include at least one of a sender input window 510, a recipient input window 512, a reference input window 514, a message title input window 516, a message input window 518, a virtual keypad 520, and an attachment file input window (not shown). Further, a graphic object 522 related to the message transmission function may be outputted to the execution screen. When a touch is applied to the graphic object 522, the controller 180 may transmit the message inputted to the message input window 518 to another party that is inputted to the recipient input window 512.

The message is generated by a user input and inputted to a message input window 518, and may be formed in various manners. For instance, a message may be generated according to a touch input applied to the virtual keypad 520 outputted to the touch screen 151, and inputted to the message input window 518. For another instance, voice received by a microphone may be converted into a text by a voice recognition function and inputted to the message input window 518.

The message may include not only a text, but also various types of multimedia information such as an image, an emoticon, an audio, and a video,

Next, when the message includes content related to a file attachment, the controller 180 may output one or more files that can be attached to the message in a selectable link form (S430).

When a message is inputted to the message input window 518, the controller 180 may monitor whether content related to a file attachment is included in the inputted message. For instance, when content implying a file attachment, such as “please check the attached file”, “Encl”, “file is transmitted”, is included in the message, the controller 180 may determine that the content related to a file attachment is included in the inputted message.

The content related to the file attachment may be reset in the memory 170 so as to be monitored. Specifically, a specific word, a specific phrase, and a specific character may be restored in the memory 160 for monitoring purpose, and the controller 180 may determine whether the content related to the file attachment is included in the message by checking whether the inputted message includes an object to be monitored.

The objects to be monitored may be set by a manufacturer of the mobile terminal 100 while releasing the products, or may be added or edited by a user of the mobile terminal 100. An interface to add or edit the objects to be monitored may be provided by the mobile terminal 100.

When content related to the file attachment is included in the message as a result of monitoring, the controller 180 may select one or more files corresponding to the file attachment among a plurality of files stored in the memory 170.

The message may include information that implies a specific file. Thus, the controller 180 may select a file corresponding to content related to the file attachment using the information included in the message. That is, the controller 180 may extract information that may be used in recommending an attachment file to the message, and search and select at least one file to be recommended to a user, using the extracted information.

For instance, when the title of message includes ‘task file transmission’ 530, the content of message includes ‘file being processed’ (532), as shown in FIG. 5, the controller 180 may select a file that is most recently processed or a file most recently modified.

For another instance, the message may include information that implies a file name to be attached such as, ‘contact details sending’, ‘draft sending’, and the like.

In case of the ‘contact details sending’, the controller 180 may select a file that includes a “contact details’ in the file name. When the file including a plurality of “contact details’ in the file name, it may select a predetermined number of files that is recently modified after aligning the files in the order of the modified time.

For still another instance, when content included in a specific file is extracted and inputted to a message, or captured and inputted to a message as an image, the controller 180 may select the specific file to be recommended to a user.

Since the controller 180 selects a file based on content included in a message, the selected file may be varied according to the content included in the message. That is, one or more files that are outputted in a link form may be varied according to content related to the file attachment.

When the file is selected, the controller 180 controls the touch screen 151 to output the selected one or more files in a selectable link form to one region of the touch screen 151. In this instance, an execution screen of an application corresponding to the message preparation function is outputted to the entire region of the touch screen 151, and a popup window 540 that outputs one or more files in a selectable link form is outputted to one region of the touch screen 151.

The size of the popup window may be varied according to the number of the files displayed on the popup window. For another instance, the size of the popup window may be preset, and when there are much more files than the preset number, a scroll bar may be generated.

The popup window may be displayed on any position of the touch screen 151. However, the popup window is displayed on a vacant space where a graphic object associated with a control function and content of a message are not displayed, so as to prevent in advance inconvenience that may occur when a user prepares a message.

Meanwhile, one or more files selected by the controller 180 may be outputted to the popup window 540 in the form of link. The link is indicative of a means for providing a connection to move to a designated file, and may include a text, an image and an icon. For instance, the popup window 540 may include a link composed of at least one of the title of a selected file, an execution icon of a selected file, and an image corresponding to content included in a selected file.

When the selected one or more files are plural, the plural files are stored in different directories, and the plural files stored in different directories may be outputted to the popup window 540 together in a selectable link form.

In general, since the files stored in different directories are not displayed together, a user has to view many directories in order to search a file to be attached. However, according to the mobile terminal in accordance with the present invention, it is possible to recommend a related file to a user by displaying at a time files stored in different directories based on information included in a message.

Meanwhile, when content related to the file attachment is included in the inputted message, the controller 180 may emphatically output the content related to the file attachment or information used for recommending an attached file. For instance, as shown in FIG. 5, information used to select a file, such as ‘task file send’, or ‘file being processed’, may be highlighted. Here, the highlight may mean that, for instance, the thickness, color or font of a character is differently displayed, or an opaque image is displayed in an overlapped manner with corresponding information like a highlighter effect.

Thus, since one or more files that may be attached to a message by information included in the message are automatically recommended by a mobile terminal, a user does not need to search a file to be attached one by one and can visually check the file to be attached without forgetting to attach a file.

Next, when at least one of the one or more files outputted in a link form is selected, the controller 180 attaches the selected at least one to the message (S450).

The controller 180 senses a touch input applied to at least one of the one or more files outputted in a link form.

In response to the touch input, the controller 180 may perform different controls according to the type of the touch input. For instance, when a short touch is applied to any one file outputted in a link form, contents included in the corresponding file is outputted, while when a long touch is applied, the link of the corresponding file may disappear from the touch screen 151. With reference to this embodiment, when a drag input is applied to any one file outputted in a link form, the controller 180 may attach the corresponding file to the message. However, the present invention is not limited to this, but a plurality of files may be selected by a touch input and may be modified such that various controls may be performed according to the types of a touch input.

For instance, as shown in FIG. 5, when a drag and drop type touch input, that moves any one file outputted in a link form to the message input window 518, is applied, the controller 180 may attach the corresponding file to the message.

When the attachment is completed, information 550 related to the attached file may be additionally displayed on the execution screen. The information 550 related to the attached file may include at least one of the title of the attached file, the type of the attached file and the size of the attached file. Further, the one or more files outputted in a link form from the execution screen disappear from the touch screen 151. That is, the controller 180 terminates output of the popup window 540.

In case of a mobile terminal, there has been inconvenience in that it is required to convert a screen one by one in order to attach a file to a message, due to the restriction of the size of the display unit. However, according to the mobile terminal 100 in accordance with the present invention, since the file to be attached is automatically recommended according to the content of message and the file to be attached is displayed on the popup window, a user can select a file to be attached while checking the content of message. Thus, it is possible to attach a file without a separate screen conversion, thereby increasing user's convenience.

Hereinafter, the operation of the mobile terminal according to the present invention will be specifically described with reference to the attached drawings.

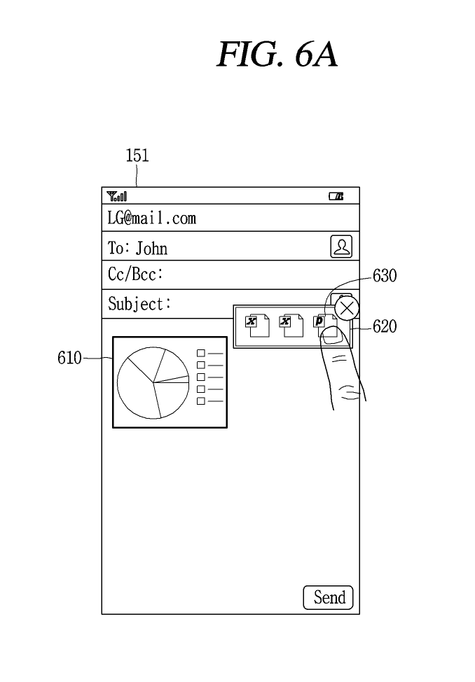

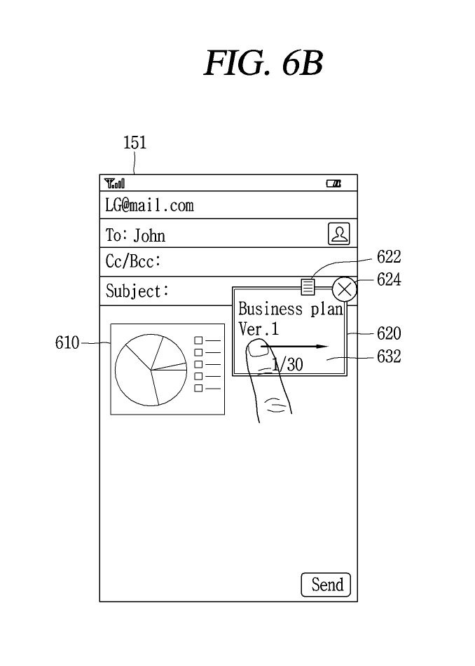

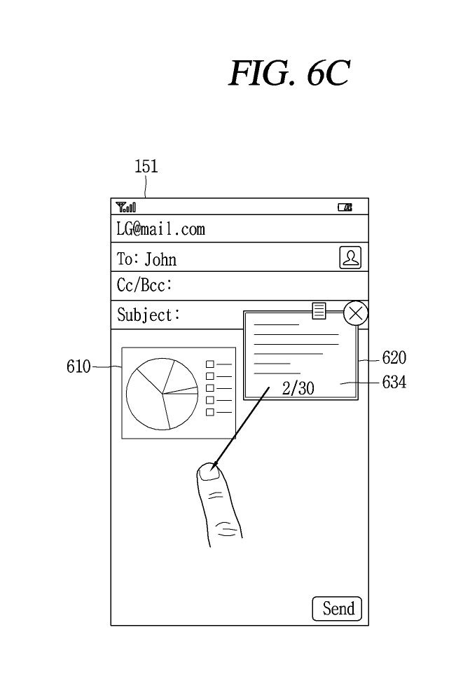

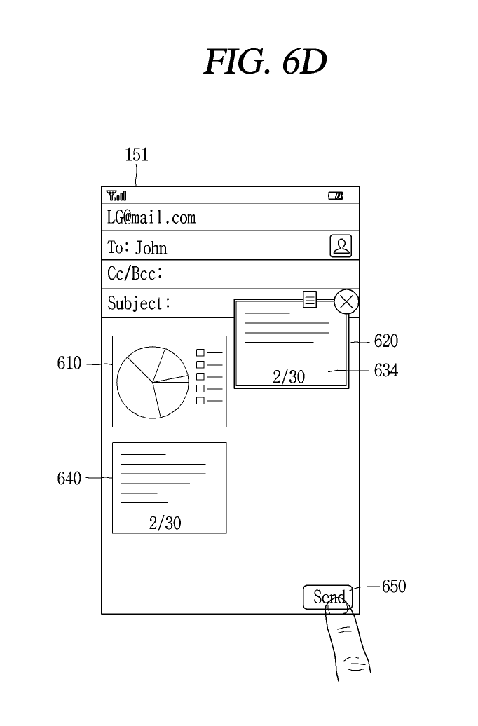

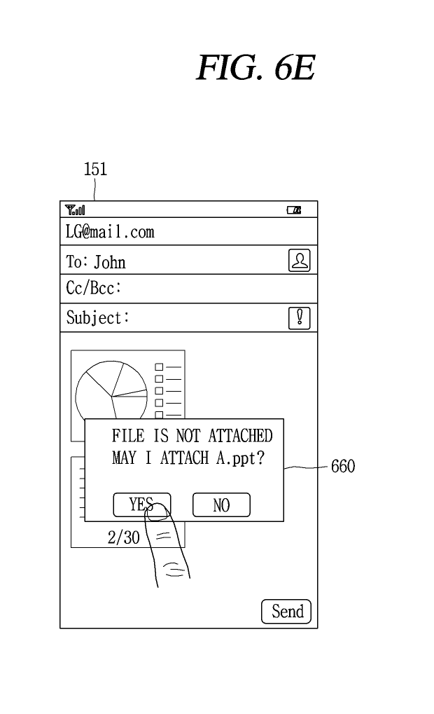

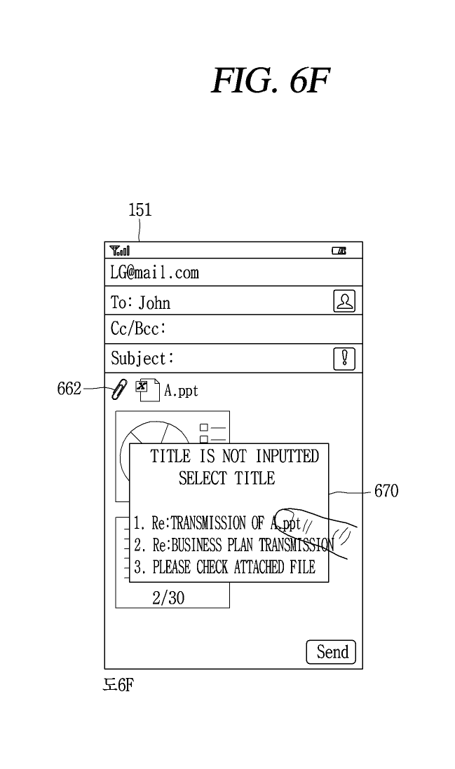

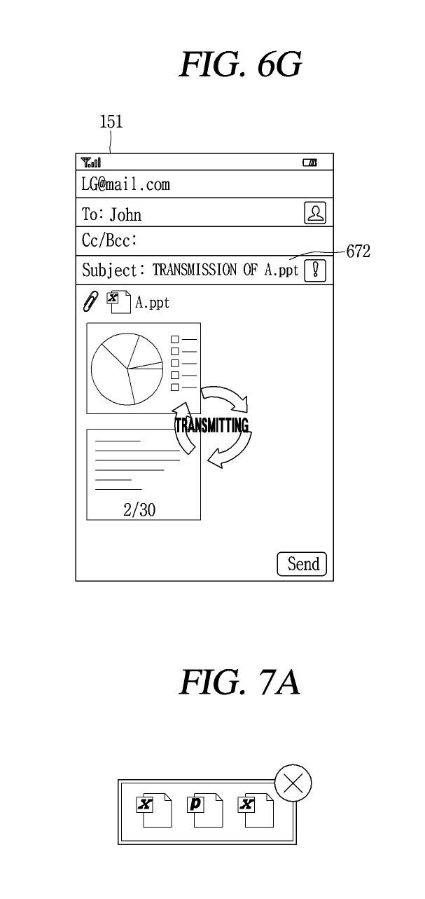

FIGS. 6A through 6G are exemplary views for explaining operations of the mobile terminal according to the present invention.

When a message is inputted to a message input window and the inputted message includes content related to a file attachment, one or more files corresponding to the content related to the file attachment are outputted to one region of the touch screen 151 in a link form.

For instance, as shown in FIG. 6A, a diagram 610 is prepared in the Excel program and the prepared diagram may be used in the Word program or the Power point program. Moreover, the diagram 610 may be temporarily stored in the memory 170 by the copying or clipping function, and then pasted to the message input window.

In this instance, the controller 180 may search a file including the diagram 610 among the files stored in the memory 170, and display the searched file to one region of the touch screen 151 in a link form. For instance, a popup window 620 may be displayed on one region of the touch screen 151 and the searched file may be displayed on the popup window 620 in a link form. However, the present invention is not limited to this, but the searched file may be displayed on one region of the touch screen 151 in various manners.

The controller 180 may perform a search simultaneously with inputting the diagram 610. That is, a search may be executed even by an input of a message to a message input window, though a separate user input is not applied. As a result, the mobile terminal 100 may operate as a robot having an artificial intelligence as if it is a secretary of a user.

When a touch input is applied to any one file among the one or more files outputted in a link form, the controller 180 controls the touch screen 151 to output contents included in the any one file to one region of the touch screen 151.

The contents may mean all sorts of information or their contents outputted through the mobile terminal 100. The file is a group of data and stored in the memory 170, and the contents may mean the data, such as documents, sounds, pictures and videos included in the file.

For instance, as shown in FIG. 6A, when a short touch is applied to any one file 630, contents 632 included in the any one file 630 are displayed, instead of the one or more files, on the popup window 620, as shown in FIG. 6B.

The contents may be at least part of the data included in the file. For instance, the contents may be at least one page among a plurality of pages constituting the file. In this instance, the number of the page being outputted may be displayed together with the page being outputted. For instance, as shown in FIG. 6B, the contents 632 may be the first page included in the any one file 630.

When the contents 632 included in the any one file 630 are displayed on the popup window 620, as shown in FIG. 6B, at least one of an X icon 624 and an index icon 622 may be generated. When the X icon 624 is touched, the popup window 620 disappears from the touch screen 151. Further, when the index icon 622 is touched, one or more files corresponding to contents related to the file attachment are displayed, instead of the contents 632, on the popup window 620.

Meanwhile it may be difficult to comprehend detailed contents included in the file only with the file name. If the file is selected and executed one by one, there may be inconvenience in that a file conversion has to be executed. However, according to the mobile terminal 100 in accordance with the present invention, it is possible to display detailed contents of a specific file on one region of the touch screen 151 in a state that a message input window is displayed. Thus, it is possible not only to check detailed contents of a specific file without a screen conversion, but to input a message to a message input window, while checking the detailed contents.

Meanwhile, a new control command may be executed according to a touch input applied to the contents in a state that the output of the contents is maintained. For instance, information being outputted may be varied according to a flicking input applied to the contents. That is, any one page among a plurality of pages that constitute the any one file 630 may be converted into another page.

For instance, as shown in FIG. 6B, when a flicking input moving to the right is received in a state that the first page 632 is outputted among a plurality of pages that constitute the any one file 630, a second page 634 different from the first page 632 is outputted, as shown in FIG. 6C. The second page 634 may be a page in the next order of the first page 632. That is, when a user applies a flicking pressure in the left and right sides, the pages may be outputted in order, thereby a user can specifically check detailed contents of the any one file 630.

Meanwhile, when a drag input toward a region where the message is outputted from the one region of the touch screen 151 is received while the contents are outputted to the one region of the touch screen 151, the controller 180 may insert the contents as the content of message.

For instance, as shown in FIG. 6C, a drag input moving from the one region of the popup window 620 to the message input window may be received while the second page 634 among the plurality of pages that constitute the any one file 630 is outputted to the popup window 620.

In this instance, as shown in FIG. 6D, the controller 180 may insert the contents being outputted to the popup window 620 based on the drag input. The point that the drag input is released may be a position where the contents are inserted.

Insertion of the contents may be executed in various manners. For instance, the controller 180 may capture the contents being outputted to the popup window 620 as an image, and insert the captured image 640 as a content of message. Total contents of the corresponding page may be captured and inserted as one image. Though not shown, the controller 180 may copy the contents being outputted to the popup window 620 as they are and paste the contents as the content of message. That is, the text included in the contents is inserted as a text and the image therein is inserted as an image.

Thus, a user can simply add the contents included in a specific file to a message.

Meanwhile, when a transmission command for a message is received, the message inputted to a message input window is transmitted to an opponent party that is inputted to a recipient input window. However, when a message is received with an attached file missed, while the message includes a content related to the file attachment, a message transmission is restricted.

For instance, as shown in FIG. 6D, a touch may be applied to a transmission icon 650 in a state that the contents of a specific file are inserted into the message. In this instance, as shown in FIG. 6E, the controller 180 outputs notification information 660 in at least one of the visual, aural and tactile methods to notify missing of the attached file, and restricts the transmission of message. That is, when a transmission command for the message is received in a state that an attached file is missed while the message includes content related to the file attachment, the transmission of message is restricted.

A user confirms missing of the attached file through the notification information 660 and selectively performs a file attachment so that the transmission of message with the attached file missed can be prevented.

Meanwhile, there may be the case where the title is missed in the message title input window, though the file is attached. In this instance, the controller 180 may generate a title of message using the file name of the attached file 662, and input the generated title to the message title input window. For instance, as shown in FIG. 6F, when a title of message is not inputted, the touch screen 151 is controlled to generate plural candidate titles using the file names of the attached file and output the generated title candidates 670. When any one of the title candidates is selected by a user input, as shown in FIG. 6G, the selected any one title candidate is inputted as the title of the message 672.

Errors, such as missing of an attached file and omission of the title of message, may be in advance prevented, and a user can simply attach a file, or insert a title of message using an interface provided by the mobile terminal.

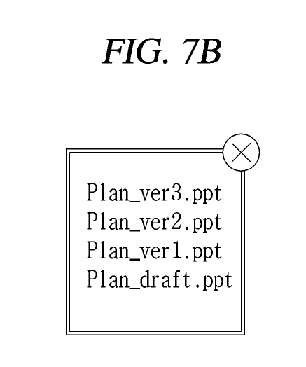

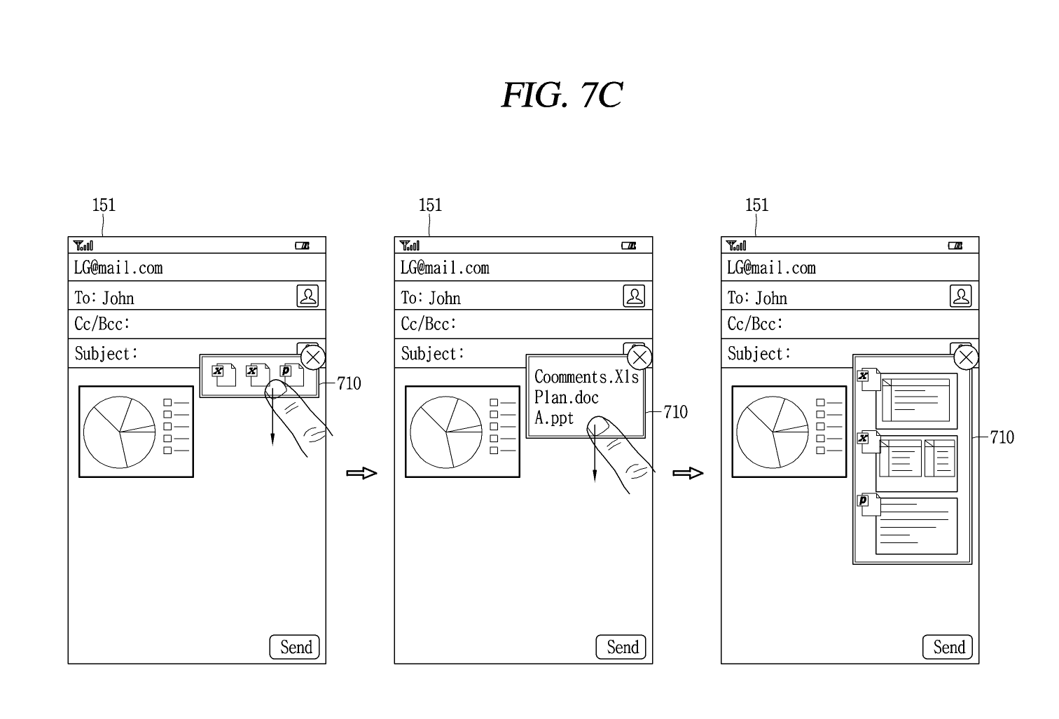

FIGS. 7A through 7C are conceptual views for explaining a method to recommend a related file based on content related to a file attachment.

The controller 180 searches a related file using information included in the message, and provides an interface that enables the searched file to be attached to the message to a user. In this instance, a file that a user really wishes to attach has to be recommended, and an interface that can easily confirm whether the recommended file is the user's desired one has to be provided.

To this end, the controller 180 may indicate the matching degree of files in the form of scores using the information included in the message. The controller 180 may recognize the context of the information included in the message and the meaning included in the content and search files corresponding thereto, and select the files that have the matching rate of a higher value than a specific value. That is, only the files having the matching rate higher than a specific value (for instance, 80%) may be recommended to a user.

The matching rate may be measured in various manners. The matching rate may be calculated considering synthetically the degree to include the content included in the message, the time that the file modification is executed, and the file name.

Meanwhile, one or more files that have the matching rate higher than a specific value are outputted to one region of the touch screen 151. In this instance, the one or more files may be outputted in line with the matching rate.

When the types of the one or more files are different from each other, as shown in FIG. 7A, each of the one or more files may be outputted as a link in the form of an icon indicating the types of files.

When the types of the one or more files are the same, as shown in FIG. 7B, each of the one or more files may be outputted as a link composed of the file name.

A user may generate various types of files in various versions when generating files according to the task. That is, files in various versions with respect to the same task may be generated, for instance, “A report on financial accounts of the first half of 2015 Plan-ver1”, “A report on financial accounts of the first half of 2015 Plan-ver2”, . . . , “A report on financial accounts of the first half of 2015 Plan-draft”. In this instance, it is not necessary to output all the file names, the controller 180 may generate a link using a not-duplicated part, except a duplicated part of the file name. That is, as shown in FIG. 7C, a link including part of the file name may be outputted.

Meanwhile, referring to FIG. 7C, the controller 180 may control the touch screen 151 to modify at least one of the size and position of the popup window 710 based on a touch input applied to an edge of the popup window 710. When the size of the popup window 710 is modified, the one or more files are outputted in different types according to the size of the modified popup window. Here, the different types mean that the shape of the link is outputted differently.

For instance, as shown in the first drawing of FIG. 7B, when the popup window 710 is smaller than a first reference size, each of the files may be outputted in the shape of an icon indicating the types of the file.

As shown in the second drawing of FIG. 7B, when the popup window 710 is larger than the first reference size and smaller than the second reference size by a touch input applied to the popup window 710, each of the files may be outputted in the form of text including part of the file name.

As shown in the third drawing of FIG. 7B, when the popup window 710 is larger than the second reference size, any one of the plural pages constituting the file may be displayed on the popup window 710 in a link form. That is, a user can immediately check contents included in the file.

Through this, a user can easily check whether the file recommended by the mobile terminal 100 is the file that he/her desires.

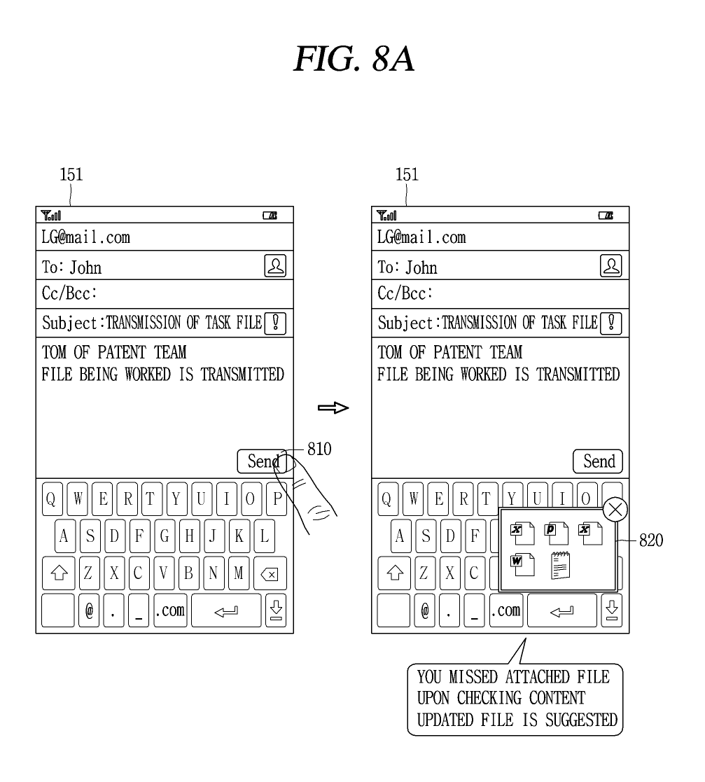

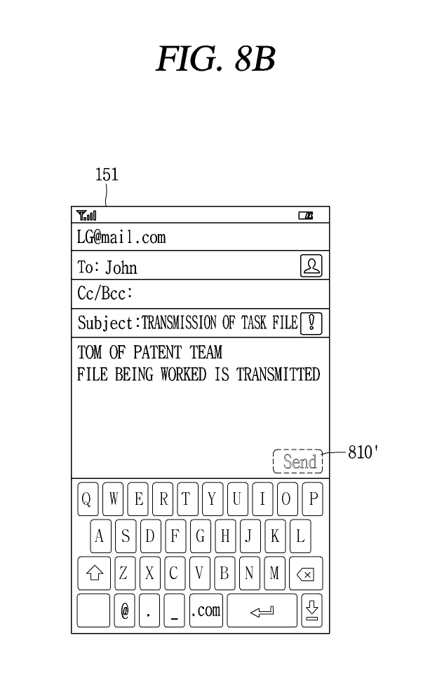

FIGS. 8A and 8B are conceptual views for explaining an operation of a mobile terminal in a case where an attached file is missed.

When an attached file is missed, the controller 180 may notify the missing of the attached file in various manners.

For instance, as shown in FIG. 8A, when a touch is applied to a transmission icon 810 in a state that content related to a file attachment is included in a message, the controller 180 may output notification information through at least one of visual, aural and tactile methods such that the missing of the message may be notified, and restrict transmission of the message. In this instance, the controller 180 may select one or more files based on the content related to the file attachment such that a user can easily attach a file, and output the selected files in a link form. That is, a popup window 820 indicating the selected files may be displayed on the touch screen 151.

For another instance, as shown in FIG. 8B, when the message includes content related to a file attachment, the controller 180 may output the popup window 820. That is, once the message includes content related to the file transmission irrespective of reception of a message transmission command, the popup window 820 may be automatically outputted. In this instance, the controller 180 may output a transmission icon 810 in an active state that the transmission icon 810 is touchable, or in an inactive state that the transmission icon 810 is untouchable according to whether the message satisfies a preset condition, such that a message transmission may be prevented in a state that a file attachment is missed. The preset condition means a state that the message includes content related to a file attachment, but not included.

When the transmission icon 810 is outputted in an inactive state that the transmission icon 810 is untouchable, the controller 180 does not perform a message transmission function though a touch is applied to the transmission icon 810, and ignores the touch. When a file attachment is executed while the transmission icon 810 is outputted in an inactive state that the transmission icon 810 is untouchable, the transmission icon 810 is converted into an active state from an inactive state such that a user can perform a message transmission function using the transmission icon 810.

The mobile terminal according to the present invention can transmit a reply message in response to a received message. When a reply message is outputted, it is possible to automatically output a file attached to the received message to one region of the touch screen 151 in a link form. Hereinafter, the operation of the mobile terminal will be described in detail with reference to the reply message.

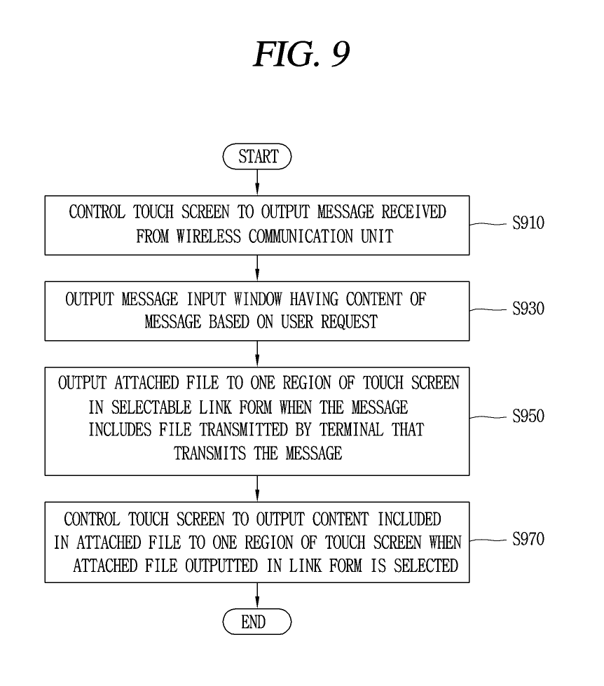

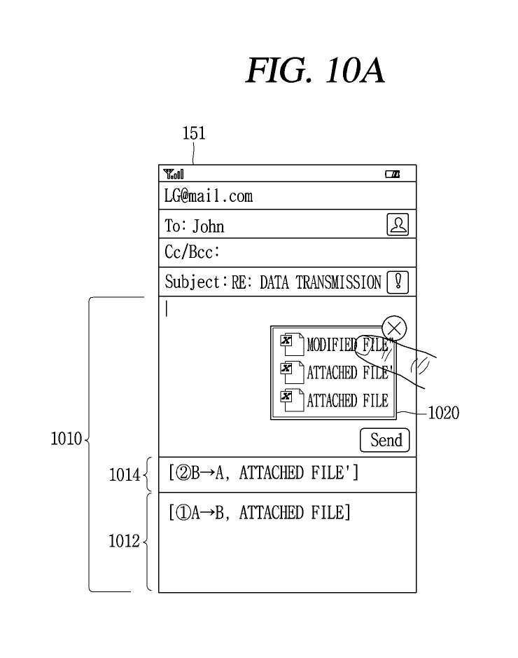

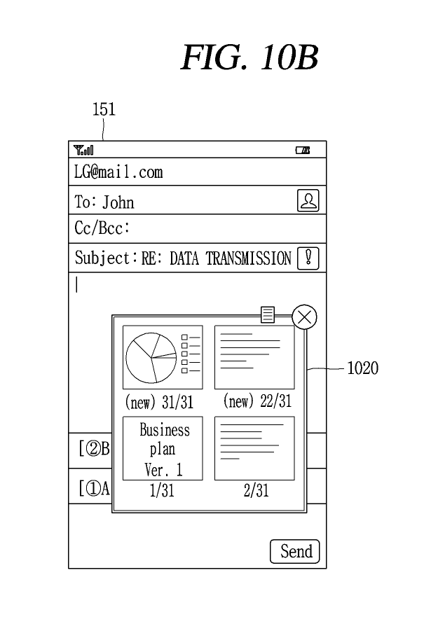

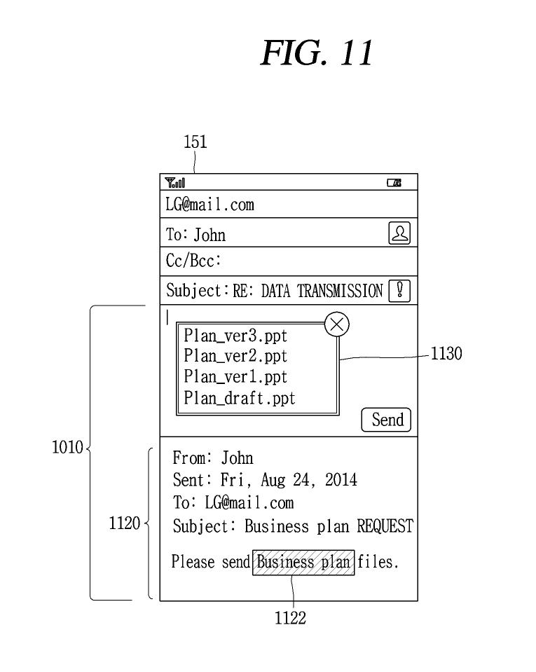

FIG. 9 is a flowchart illustrating a control method of the mobile terminal according to the present invention, and FIGS. 10A, 10B and 11 are conceptual views illustrating the control method of FIG. 9.

First, the touch screen 151 is controlled to output a message received through a wireless communication unit (S910).

The mobile terminal may output a message received from external terminals (or external devices) to the touch screen 151. In this instance, the received message may include a link message.

The link message is a message associated with the message, and may be a message that is received from or transmitted to the same external terminal before reception of the message, or a message including content related to the content of the message.

For instance, when the message is an email, the link message may be a message that has been previously transmitted by the mobile terminal to the external device, and the received message may be a reply message of the external device to the transmitted message. That is, when the link message is an original message, the received message may be a message that a reply or transfer function has been performed.

When the received message is outputted, the controller 180 may display the message such that content of the link message may be displayed on the display unit in a visually distinguishable manner.

For instance, when the message is an email and the link message is an original email, a title of the email, identification information of another party who sent the received email and content of the email may be displayed on the display unit 151. Further, content of the original email linked to the email, a title of the original email and identification information related to the original email may be displayed on the display unit 151.

Next, a message input window having content of the message may be outputted based on a user request (S930).

A reply function or a forwarding function in response to the received message may be executed based on a user request. In this instance, the controller 180 may output a message input window having content of the received message.

For instance, as shown in FIG. 10, the message input window 1010 may be outputted to the touch screen 151 in a state that the received messages 1012 and 1014 are inputted. The received messages may include an original message 1012 and a link message 1014 linked to the original message 1012. The original message 1012 is a message that is transmitted from A to B, and assumed that an “attached file” is attached. The link message 1014 is a message that is transmitted from B to A, and assumed that an “attached file” is attached. And it is assumed that a “modified file” in which the “attached file” is modified, is stored in the memory 170 of the mobile terminal 100.

Next, when the received message includes a file attached by a mobile terminal that transmits the received message, it is possible to output the attached file to one region of the touch screen 151 in a selectable link form (S950).

The controller 180 may output a file attached to a received message in a selectable link form. A popup window 1020 is displayed on one region of the touch screen 151, and the file attached to the received message is outputted in a link form.

Moreover, the controller 180 may output a modified file in which a modification is executed with respect to the attached file to the popup window 1020 in a selectable link form. In case of replying to a data transmission request, since it is general to send the attached data with modifications, the controller 180 outputs not only the file attached to the received message, but the file modified by the mobile terminal 100 in a link form.

Though not shown, when a touch input in a drag and drop method, that moves any one file to the message input window 1919, is applied, the controller 180 may attach the corresponding file to a message.

Next, when an attached file outputted in a link form is selected, the controller 180 may control the touch screen 151 to output contents included in the attached file to one region of the touch screen 151 (S970).

When a touch input is applied to any one file of the one or more files outputted in a link form, the controller 180 may control the touch screen 151 to output contents included in the any one file to one region of the touch screen 151.

For instance, as shown in FIG. 10A, when a short touch is applied to the any one file, contents included in the any one file are displayed on the popup window 1020 instead of the one or more files.

The contents may be at least part of the data included in the file. For instance, the contents may be at least one page of the plural pages constituting the file. In this instance, the page number of the page being outputted may be displayed together with the page being outputted.

In case of displaying the contents, the controller 180 may compare the transmitted/received attached files, and selectively output a page that is modified to the popup window 1020. For instance, when page No. 31 is newly added or data of existing page No. 22 is modified, page No. 31 and/or 22 may be outputted to the popup window 1020. Thus, a user can visually check a portion where a modification is executed from the file recommended by the mobile terminal.

Meanwhile, as shown in FIG. 11, when a message input window 1110 includes a received message 1120, the controller 180 may determine whether content related to a file attachment is included in the received message 1120.

When an object to be monitored is included in the received message, the controller 180 may select one or more files corresponding to content related to a file attachment among plural files stored in the memory 170, and output the selected files to a popup window 1130 in a link form.

For instance, when the received message 1120 includes contents related to a file attachment, i.e., “Please send me a file of Business Plan”, the controller 180 searches a file including the term, “Business Plan” in the file name among the files stored in the memory 170. When there are the searched files, the searched files are outputted to the popup window 1130 in a link form.

Thus, a user can simply attach a file by selecting the file recommended by the controller 180, without searching a file to be attached one by one.

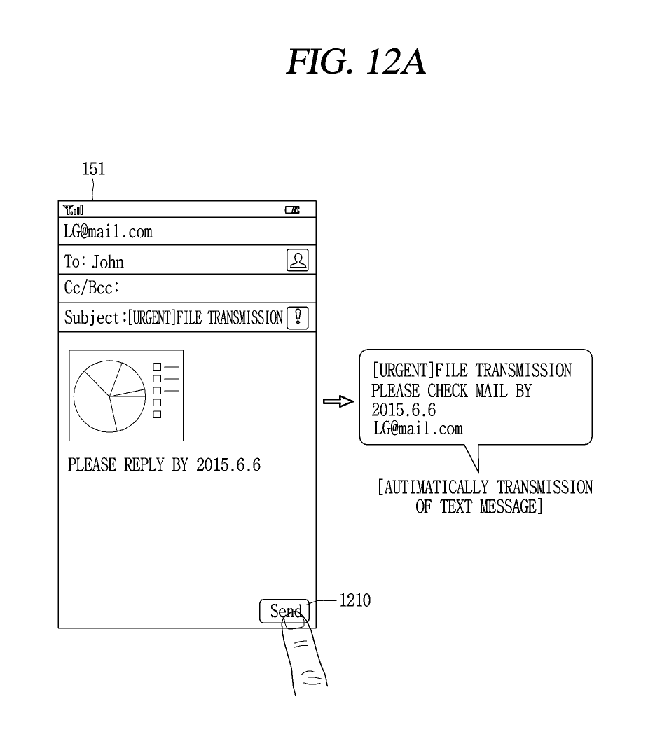

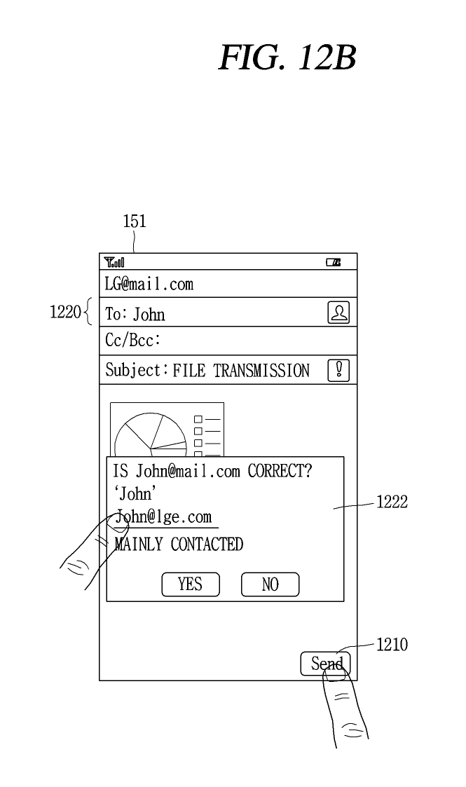

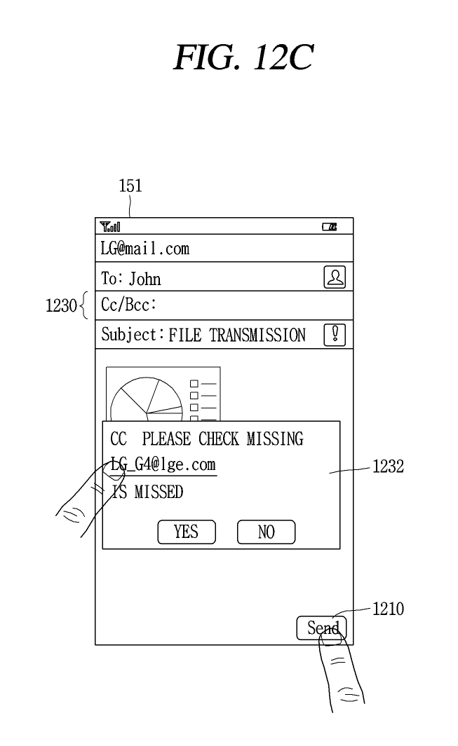

Meanwhile the mobile terminal according to the present invention may have an artificial intelligence that can take care of a user's mistake one by one. Hereinafter, this will be described in detail. FIGS. 12A through 12C are conceptual views illustrating various embodiments related to a message transmission function.

FIG. 12A is a conceptual view for explaining an embodiment to transmit a notification text to another party who will receive a message after comprehending content of a message, when a message transmission function is executed.

For instance, when content of a message includes a deadline, or the title of message includes a word, such as ‘important’, or ‘urgent’, the corresponding message may be an important message that should be checked by another party.

Accordingly, when a message transmission function is executed by applying a touch to a transmission icon 1210, the controller 180 comprehends content of the message and when the message is determined as an important message that satisfies a predetermined condition, may acquire contact details of another party who will receive the message and transmit a notification text to the opponent party. The notification text may be automatically generated by the controller 180 according to the content of message.

FIG. 12B is a conceptual view for explaining an embodiment to output a notification information to modify erroneous information, when information on another party who will receive the message is erroneously inputted.

Information on the recipients to be an object to transmit a message may be plural though the object is same another party. For instance, plural contact details, ‘john@mail.com’, and ‘john@lge.com’ may be stored in the memory 170, for another party, ‘John’. For this reason, an error may occur to send a message to the contact details that is not frequently used by another party.

When a touch is applied to the transmission icon 1210 and a message transmission function is executed, the controller 180 analyzes recipient information inputted to a recipient input window 1220. When transmission/reception of a message is usually performed with another party corresponding to the analyzed recipient information through another contact details, the controller 180 may output notification information 1222 notifying that the recipient's contact details is incorrectly recorded. In this instance, the notification information 1222 may include a main contact details to and from which message is mainly transmitted and received with another party, and when a touch is applied to the main contact details, a message is transmitted to the main contact details.

FIG. 12C is a conceptual view for explaining an embodiment to output notification information such that, when information on an opponent party who will receive a message is missed, the information on another party may be added.

In a case where a message to notice a meeting schedule is prepared, a list of participants who will participate in the meeting may be included in the content of the message. The message should be transmitted to all the participants, but may be missed to some of them in error. To prevent such an error, the controller 180 may comprehend content of the message and recommend, when a touch is applied to a transmission icon 1210 and a message transmission function is executed, the recipient of the message to a user. That is, when information on another party who will receive a message is missed, the controller 180 may output notification information 1232 such that said missed another party may be added to a person to receive the message. In this instance, the notification information 1232 may include contact details of said missed another party, and when a touch is applied to said missed another party, a message is transmitted to said missed another party.

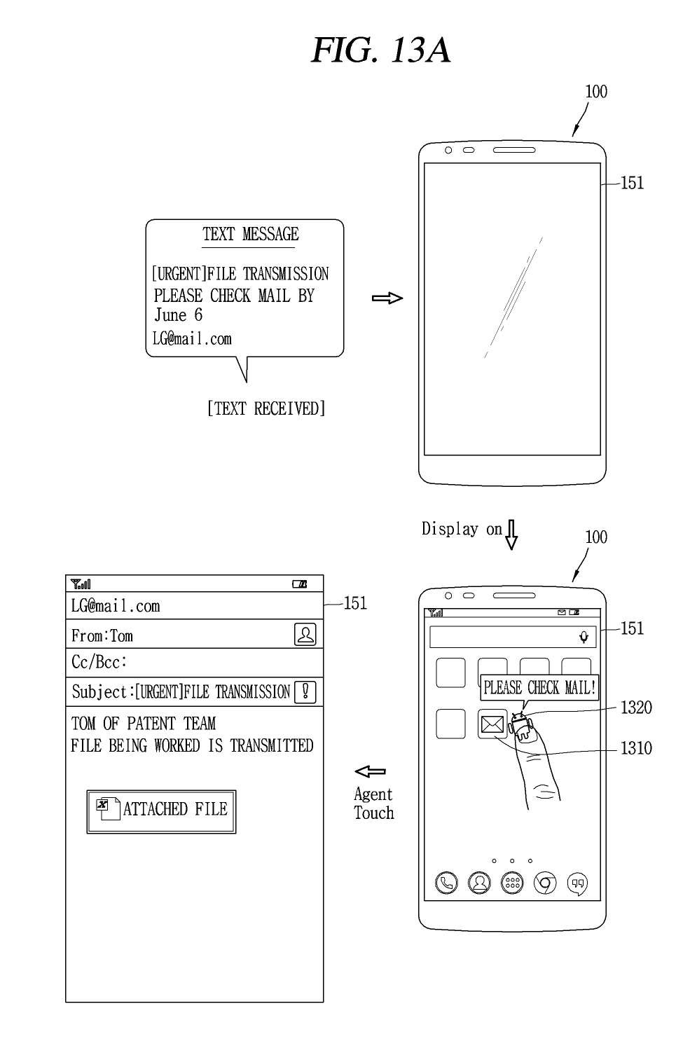

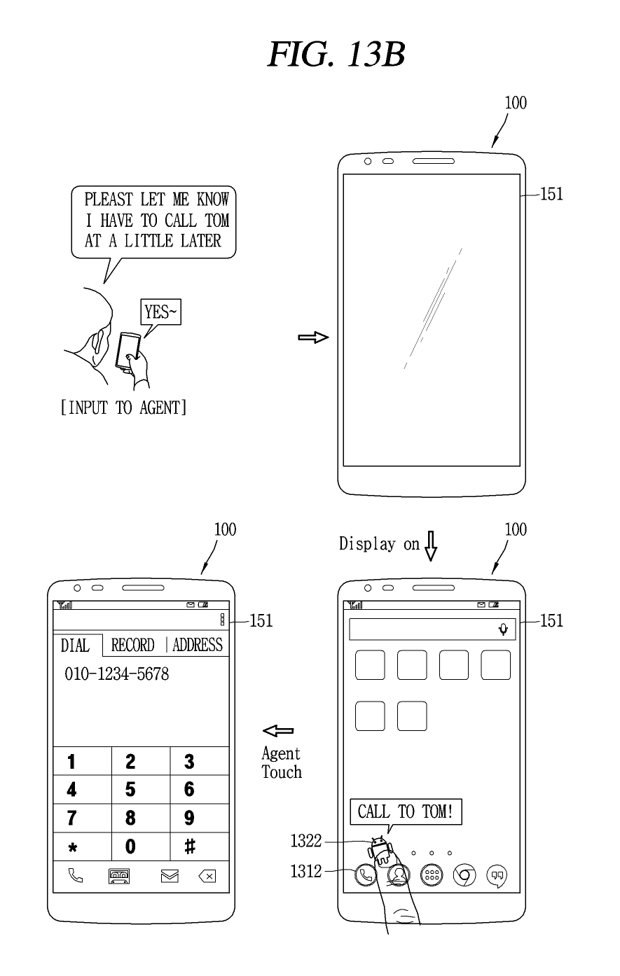

FIGS. 13A and 13B are conceptual views for explaining an artificial intelligence operation of the mobile terminal that operates as if it is a secretary of a user, according to the present invention.

As the performance of the mobile terminal is developed, an intelligent agent (IA), which performs a series of operations on behalf of a user with autonomy or independence at a certain level, is provided to the mobile terminal. The intelligent agent (IA) includes motions by the controller 180, and is characterized in that it establishes a target to meet a user's intention in dynamic environments and performs a motion corresponding to the established target. The intelligent agent (IA) may collect information without a user's involvement, and establishes a target based on the collected target.

More specifically, the controller senses that an event occurs in at least one application.

The application has the concept to include a widget or a home launcher, and means all types of programs which are operable in the mobile terminal. Thus, the program may be a program that performs functions of a web browser, a reproduction of video, transmission and reception of a message, a scheduling, and an update of an application.

The event occurrence may include, for instance, when there is a missed call, when there is an application to be updated, when a message is received, a charging, a power on, a power off, a display activation key pressed (LCD awake key), an alarm, an incoming call, and a missed notification.

For another instance, when specific information is received through a wireless communication unit of a mobile terminal, it means that an event is generated in an application related to the specific information and the controller senses it. Alternatively, when an item inputted by a user is recorded in the scheduling and it comes to the date corresponding to the item, an event is generated in the scheduling application.

The controller 180 sets an alarm by the intelligent agent (IA) based on the generated event. For instance, as shown in FIG. 13A, when a message requesting to check an email within a deadline is received from outside, an alarm to alert a user not to miss the deadline may be set. That is, an alarm may be set just by receiving the message without any separate involvement of a user.

When a text message, “Please check an email by June 6”, is received, the intelligent agent (IA) may establish a target “to have a user check the email corresponding to the message by June 6,”. That is, the intelligent agent (IA) may establish a target that does not have a user check the text message, but to check an email, and set an alarm corresponding to the established target.

When an alarm is set by the intelligent agent (IA), a graphic object 1320 corresponding to the intelligent agent (IA) may be outputted to a home screen page. The home screen page may include at least one object, and the object may be an icon or widget of an application installed in a mobile terminal.

Though not shown, the alarm may be outputted in at least one of visual, aural and tactile methods, and a user can recognize that there is an important event to be checked by the alarm.

Since the user has to check an email, not a text message, the graphic object 1320 corresponding to the intelligent agent (IA) may be displayed on a position close to the icon 1310 of the mail application. Thus, a user can determine the order of priority of an event to be checked.

When a touch is applied to the graphic object 1320 corresponding to the intelligent agent (IA), the controller 180 may operate such that the established target may be accomplished. For instance, in order to accomplish the target, i.e., “it is required for a user to check the mail corresponding to the text message by June 6”, the controller 180 controls the touch screen 151 to output “a mail corresponding to the text message” in response to the touch applied to the graphic object 1320.

Once the established target is accomplished, output of the graphic object 1320 corresponding to the intelligent agent (IA) is terminated.

Meanwhile, the intelligent agent (IA) may establish a target based on a user input and set an alarm corresponding to the established target.

As shown in FIG. 13B, when a voice, “Please let me know that I have to call Tom a little later˜,” is received from a user in a state that a voice recognition function is activated, the intelligent agent (IA) may establish a target that “call to Tom within a predetermined time”, and set an alarm such that the established target is accomplished.

When such an alarm is set, a graphic object 1322 corresponding to the intelligent agent (IA) may be displayed on a position adjacent to an icon 1312 of a call application. When a touch is applied to the graphic object 1322, an execution screen of a call application may be outputted to the touch screen 151 such that calling to Tom may be enabled upon pressing a call button.

Since the work to be done by a user is simply accomplished by pressing the graphic object corresponding to the intelligent agent (IA), a user input to be inputted to a mobile terminal can be minimized, thereby enhancing the user convenience.

The present invention can be implemented as computer-readable codes in a program-recorded medium. The computer-readable medium may include all types of recording devices each storing data readable by a computer system. Examples of such computer-readable media may include hard disk drive (HDD), solid state disk (SSD), silicon disk drive (SDD), ROM, RAM, CD-ROM, magnetic tape, floppy disk, optical data storage element and the like. Also, the computer-readable medium may also be implemented as a format of carrier wave (e.g., transmission via an Internet). The computer may include the controller 180 of the terminal.

Therefore, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

### INDUSTRIAL APPLICABILITY

Embodiments of the present invention may be applicable to various fields of industry by providing a new interface related to a message received through a wireless communication unit in a mobile terminal including a wireless communication unit, a touch screen and a controller.

1. A mobile terminal, in which a wireless communication unit, a touch screen and a controller perform a message transmission function in cooperation with each other, wherein the controller performs the message transmission function through:
controlling the touch screen to output a message prepared by a user input;
outputting one or more files attachable to the message in a selectable link form, when the message includes content related to a file attachment, using the content related to the file attachment; and
attaching, when at least one is selected from the one or more files outputted in a link form, the selected at least one to the message.

2. The mobile terminal of claim 1, wherein outputting one or more selectable files in a link form includes:
selecting, when the message includes content related to the file attachment, one or more files corresponding to the content related to the file attachment among plural files stored in a memory; and
controlling the touch screen to output the selected one or more files to one region of the touch screen in a selectable link form.

3. The mobile terminal of claim 2, wherein the controller further performs, when a touch input is applied to any one file among the one or more files outputted in a link form, controlling the touch screen to output content included in the any one file to one region of the touch screen.

4. The mobile terminal of claim 3, wherein the controller further performs, when a drag input to a region where the message is outputted from the one region of the touch screen is received while the contents is outputted to one region of the touch screen, inserting the contents as content of the message.

5. The mobile terminal of claim 4, wherein the contents is any one page among plural pages constituting the any one file.

6. The mobile terminal of claim 5, wherein inserting the contents as content of the message includes:
capturing the any one page as an image in response to the drag input; and
inserting the captured image as the content of message.

7. The mobile terminal of claim 5, wherein the controller further performs, when a touch input is applied to one region of the touch screen while the any one page is outputted from the one region of the touch screen, converting the any one page into another page based on the applied touch input.

8. The mobile terminal of claim 5, wherein, when the any one page is outputted to one region of the touch screen, a page number corresponding to the any one page is outputted to the any one page.

9. The mobile terminal of claim 2, wherein, when the selected one or more files are plural, the plural files are stored in different directories, and the plural files stored in different directories are outputted together to one region of the touch screen in a selectable link form.

10. The mobile terminal of claim 1, wherein a graphic object associated with the message transmission function is outputted together with the message, and
wherein the controller further performs outputting the graphic object in an active state that the graphic object is touchable, or in an inactive state that the graphic object is untouchable according to whether the message satisfies a preset condition.

11. The mobile terminal of claim 1, wherein the one or more files are varied according to content related to the file attachment.

12. The mobile terminal of claim 1, wherein an execution screen of an application corresponding to the message preparation function is outputted to an entire region of the touch screen, and a popup window that outputs the one or more files in a selectable link form is outputted to one region of the touch screen.

13. The mobile terminal of claim 12, wherein the controller further performs:
controlling the touch screen to modify at least one of a size and position of the popup window based on a touch applied to an edge of the popup window; and
outputting, when the size of the popup window is modified, the one or more files in different manners according to the modified size of the popup window.

14. The mobile terminal of claim 12, wherein the size of the popup window is varied according to the number of the one or more files.

15. The mobile terminal of claim 1, wherein the controller further performs, when at least one is selected among the one or more files outputted in a link form, generating a title of the message using the selected at least one file name.

16. The mobile terminal of claim 1, wherein the controller further performs, when a transmission command to the message is received in a state that an attached file is missed, but the message includes content related to the file attachment, outputting a notification information in at least one of visual, aural and tactile methods to notify missing of the attached file; and restricting a transmission of the message.

17. The mobile terminal of claim 1, wherein, when at least one is selected from the one or more files outputted in a link form, the one or more files outputted in a link form disappear from the touch screen.

18. A mobile terminal, in which a wireless communication unit, a touch screen and a controller perform a message transmission function in cooperation with each other, wherein the controller performs the message transmission function through:
controlling the touch screen to output a message received through the wireless communication unit;
outputting a message preparation window including content of the message, based on a user request;
outputting, when the message includes a file attached by a transmitter terminal that transmits the message, the attached file to one region of the touch screen in a selectable link form; and
controlling, when the attached file outputted in a link form is selected, the touch screen to output contents included in the attached file to one region of the touch screen.

19. The mobile terminal of claim 18, wherein, when the attached file is modified by a user input and stored in a memory, a graphic object corresponding to the file stored in the memory is further outputted to one region of the touch screen.

20. The mobile terminal of claim 19, wherein, when a touch input is applied to the graphic object, the controller controls the touch screen to output contents included in the file stored in the memory to one region of the touch screen.
